(19) United States
(12) Patent Application Publication
(10) Pub. No.: US 2020/0208438 A1
(43) Pub. Date: Jul. 2, 2020

(54) Motorized Cylinder for Door Hardware

(71) Applicant: Accurate Lock & Hardware Co. LLC, Stamford, CT (US)

(72) Inventors: Francis Colligan, New Haven, CT (US); Kevin T. Debacher, Bethel, CT (US)

(21) Appl. No.: 16/728,804

(22) Filed: Dec. 27, 2019

Related U.S. Application Data
(60) Provisional application No. 62/785,562, filed on Dec. 27, 2018.

(51) Int. Cl. E05B 47/00; E05B 63/08

(52) U.S. Cl. CPC E05B 47/0012; E05B 63/08; E05Y 2900/132; E05B 2047/002; E05B 2047/0024; E05B 2047/0091

(57) ABSTRACT

A motorized deadbolt cylinder assembly includes a housing having a generally cylindrical side wall, a generally planar outer end wall disposed at a first end of the side wall and a generally planar inner end wall disposed at a second end of the side wall opposite to the first end. The assembly also includes a motor disposed within the housing, the motor having a drive shaft, and a cam arranged on the inner end wall and arranged such that at least a portion thereof is disposed outside of the housing. A gear train is operably connected between the drive shaft of the motor and the cam such that rotation of the drive shaft of the motor causes rotation of the cam, such that the cam rotates with an increase in mechanical advantage as compared to rotation of the drive shaft of the motor.

### FIELD OF THE INVENTION

The present invention relates to a motorized deadbolt for use in connection with securing a door, and more particularly, to a motorized cylinder that may be retrofit to replace a standard deadbolt cylinder without requiring a complete redesign of the deadbolt.

### BACKGROUND OF THE INVENTION

Deadbolts have been used for decades as a means of securing doors in a closed position. As is known, a deadbolt typically includes a cylinder that may be rotated by a user, typically employing a key on at least one side of a door. The opposite side of the door side may also require a key, but often employs a thumb turn instead that allows for the deadbolt cylinder to be rotated without a key, for example to provide easier egress from inside a building. Also as is known, the rotation of the cylinder is translated into linear motion of the deadbolt in order to extend and retract the deadbolt, thereby locking or unlocking the door. Typically, this translation of rotational into linear movement is accomplished by a cam attached to the cylinder, which cam cooperates with a mating portion on the linearly throwable deadbolt.

More recently, motorized deadbolts have been developed, which employ a motor or a solenoid, instead of or in addition to a key, to rotate the cylinder. This allows for the door to be locked and/or unlocked without a physical key being necessary to rotate the cylinder. For example, the Bluetooth capabilities of a mobile device (e.g., a mobile phone) may be employed, a key fob may be employed, a number pad or touch pad may be employed, etc. In any of these cases, once an unlocking command is triggered, a motor may be used to rotate the cylinder to unlock and/or lock the door.

However, known motorized deadbolts generally require a complete redesign of the entire deadbolt assembly so that the entire assembly is specially configured to accommodate the motorization. Moreover, known motorized deadbolts have traditionally been large, and generally involve box- like structures being affixed to the inner face of the door, the outer face of the door, or both. These relatively large, box-like structures are often aesthetically unappealing.

What would be desirable instead would be a motorized deadbolt assembly having a motorized cylinder capable of being installed within the envelope of typical deadbolt designs (i.e., not requiring additional aesthetically unappealing structures mounted on the inner and/or outer surfaces of the door). It would also be desirable to provide a motorized cylinder that could be retrofit for use with existing deadbolt designs, such that significant redesign thereof would not be required. For example, it would be advantageous to provide a motorized cylinder that could be used in connection with existing mortise locks without significant redesign thereof.

### SUMMARY OF THE INVENTION

Accordingly, it is an object of the present invention to provide a motorized deadbolt assembly having a motorized cylinder capable of being installed within the envelope of typical deadbolt designs.

It is a further object of the present invention to provide a motorized cylinder that could be retrofit for use with existing deadbolt designs, such that significant redesign thereof would not be required.

These and other objectives are achieved, in accordance with a first aspect of the invention, by providing a motorized deadbolt cylinder assembly including a housing having a generally cylindrical side wall, a generally planar outer end wall disposed at a first end of the generally cylindrical side wall and a generally planar inner end wall disposed at a second end of the generally cylindrical side wall opposite to the first end. The assembly also includes a motor disposed within the housing, the motor having a drive shaft, and a cam arranged on the generally planar inner end wall and arranged such that at least a portion thereof is disposed outside of the housing. A gear train is operably connected between the drive shaft of the motor and the cam such that rotation of the drive shaft of the motor causes rotation of the cam, such that the cam rotates with an increase in mechanical advantage as compared to rotation of the drive shaft of the motor.

In some embodiments, the generally cylindrical side wall has a longitudinal axis, the drive shaft of the motor has a longitudinal axis, and the longitudinal axis of the generally cylindrical side wall and the longitudinal axis of the drive shaft of the motor are parallel. In some embodiments, the cam comprises a generally planar clover cam which is disposed to be generally parallel to the generally planar inner end wall. In certain of these embodiments, the generally planar clover cam rotates in a plane that is generally parallel to the generally planar inner end wall.

In some embodiments, the generally cylindrical side wall has a longitudinal length less than about 1.5 inches, whereby the assembly is adapted to be arranged such that the cam is disposed on a centerline of a door with the housing being completely disposed to one side of the centerline of the door. In some embodiments, the motor comprises a direct current motor. In certain of these embodiments, the gear train is formed as a unit as part of the direct current motor.

In some embodiments, the gear train comprises a plurality of gears disposed between the generally planar outer end wall and the generally planar inner end wall. In certain of these embodiments, each of the plurality of gears rotates about an axis extending between, and arranged generally perpendicular to, the generally planar outer end wall and the generally planar inner end wall. In certain embodiments, the gear train comprises a first gear which is driven by the drive shaft of the motor, a second gear comprising a larger diameter section and a smaller diameter section, the larger diameter section being driven by the first gear, and a third gear driven by the smaller diameter section of the second gear, the third gear driving the cam. In certain of these embodiments, a rotatable shaft extends through the generally planar inner end wall, a first portion of the rotatable shaft being affixed to the third gear, and a second portion of the rotatable shaft being affixed to the cam.

In some embodiments, the housing further comprises an attachment section adapted to be attached to a mortise lock body. In certain of these embodiments, the attachment section of the housing comprises male threads disposed on an outer surface of the generally cylindrical side wall, the male threads adapted to cooperate with female threads disposed on the mortise lock body.

In accordance with another aspect of the present invention, a motorized mortise lock assembly includes a mortise lock body having deadbolt components disposed therein and having an opening formed therein through which the deadbolt components are accessible, the mortise lock body defining a generally planar centerline, with the opening being generally perpendicular to the generally planar centerline. The assembly also includes a deadbolt cylinder housing having a generally cylindrical side wall, a generally planar outer end wall disposed at a first end of the generally cylindrical side wall and a generally planar inner end wall disposed at a second end of the generally cylindrical side wall opposite to the first end. A motor is disposed within the deadbolt cylinder housing, the motor having a drive shaft, while a cam is arranged on the generally planar inner end wall and is arranged such that at least a portion thereof is disposed outside of the deadbolt cylinder housing. A gear train is operably connected between the drive shaft of the motor and the cam such that rotation of the drive shaft of the motor causes rotation of the cam, such that the cam rotates with an increase in mechanical advantage as compared to rotation of the drive shaft of the motor, and such that the portion of the cam disposed outside of the deadbolt cylinder housing cooperates with the deadbolt components of the mortise lock body upon rotation of the cam. The cam and the deadbolt cylinder housing are arranged such that the cam is disposed on the centerline of the mortise lock body and the deadbolt cylinder housing is completely disposed to one side of the centerline of the mortise lock body.

In some embodiments, the generally cylindrical side wall has a longitudinal length less than about 1.5 inches. In some embodiments, the generally cylindrical side wall has male threads formed on an outer surface thereof, the opening formed in the mortise lock body has female threads formed therein, and the deadbolt cylinder housing is attached to the mortise lock body by way of the male and female threads.

In some embodiments, the generally cylindrical side wall has a longitudinal axis, the drive shaft of the motor has a longitudinal axis, and the longitudinal axis of the generally cylindrical side wall and the longitudinal axis of the drive shaft of the motor are parallel. In some embodiments, the cam comprises a generally planar clover cam which is disposed to be generally parallel to the generally planar inner end wall. In certain of these embodiments, the generally planar clover cam rotates in a plane that is generally parallel to the generally planar inner end wall.

In some embodiments, the gear train comprises a plurality of gears disposed between the generally planar outer end wall and the generally planar inner end wall. In certain of these embodiments, each of the plurality of gears rotates about an axis extending between, and arranged generally perpendicular to, the generally planar outer end wall and the generally planar inner end wall. In certain of these embodiments, the gear train comprises a first gear which is driven by the drive shaft of the motor, a second gear comprising a larger diameter section and a smaller diameter section, the larger diameter section being driven by the first gear, and a third gear driven by the smaller diameter section of the second gear, the third gear driving the cam. In certain of these embodiments, a rotatable shaft extends through the generally planar inner end wall, a first portion of the rotatable shaft being affixed to the third gear, and a second portion of the rotatable shaft being affixed to the cam.

Other objects of the invention and its particular features and advantages will become more apparent from consideration of the following drawings and accompanying detailed description.

### BRIEF DESCRIPTION OF THE DRAWINGS

FIG. 1 is an exploded side isometric view of a motorized deadbolt cylinder assembly according to an exemplary embodiment of the present invention.

FIG. 2 is a side elevational view of the motorized deadbolt cylinder assembly of FIG. 1.

FIG. 3 is a side isometric view of the motorized deadbolt cylinder assembly of FIG. 1 shown attached to a mortise lock body.

### DETAILED DESCRIPTION OF THE INVENTION

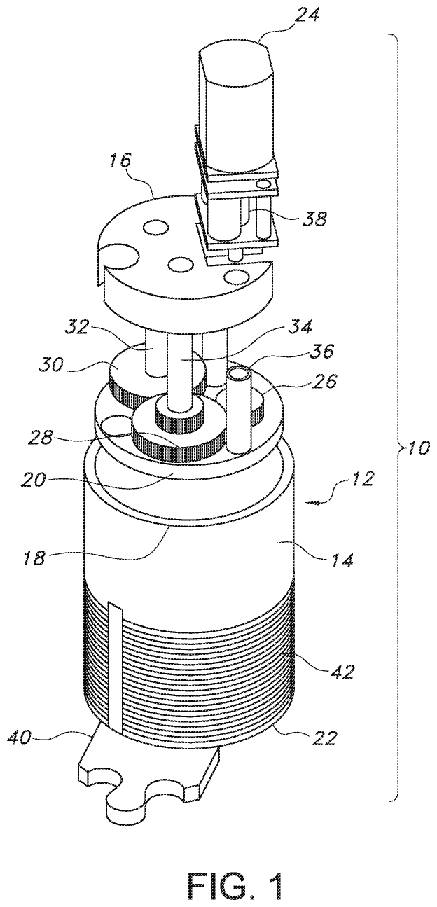

Referring now to the drawings, wherein like reference numerals designate corresponding structure throughout the views, FIG. 1 illustrates a motorized cylinder (10) according to one aspect of the present invention, which motorized cylinder (10) may be retrofit to replace a standard deadbolt cylinder of a door without requiring a complete redesign of the deadbolt.

The motorized cylinder (10) includes a housing (12), defined by a generally cylindrical side wall (14) a generally planar outer end wall (16) disposed at a first end (18) of the side wall (14) and a generally planar inner end wall (20) disposed at a second end (22) of the side wall (14) opposite to the first end (18). As is discussed in more detail below, the housing (12) is configured for carrying and housing the various components of the motorized cylinder (10).

A relatively small gearmotor (24) is provided, which provides the power necessary to retract and/or throw the deadbolt. The gearmotor (24) is preferably a direct current (DC) motor, for example, operating at 12 volts (although other voltages are also possible). However, it is envisioned that an alternating current (AC) motor could be employed instead.

As is known, DC motors generally operate best with relatively high RPMs and relatively low torque. Thus, a robust gear train is provided to convert said higher RPM/lower torque movement into lower RPM/higher torque movement. In particular, as is known, deadbolts may require relatively high torque to extend and/or retract, due for example, to frictional losses between internal components and between the deadbolt and the door frame, particularly if force is applied to the door while the deadbolt is being retracted and/or extended. Thus, the torque of the gearmotor (24) must be sufficient to overcome these frictional forces.

The aforementioned gear train may include, for example, gears (26, 28, 30) mounted between inner end wall (20) and outer end wall (16) by way of various shafts/pins (32, 34, 36), etc. In the embodiment shown, the gear train comprises a first gear (26) which is driven by the drive shaft (38) of the gearmotor (24), a second gear (28) comprising a larger diameter section and a smaller diameter section, the larger diameter section being driven by the first gear (26), and a third gear (30) driven by the smaller diameter section of the second gear (28). In the embodiment shown, the first gear (26) and the smaller diameter section of the second gear (28) have 16 teeth, while the third gear (30) and the larger diameter section of the second gear (28) have 32 teeth. However, other configurations are certainly possible.

In the embodiment shown, the first gear (26) is carried by the drive shaft (38) of the gearmotor (24), the second gear (28) is carried on a rotating shaft (34) disposed between inner end wall (20) and outer end wall (16) and the third gear (30) is carried on a rotating shaft (32) disposed between inner end wall (20) and outer end wall (16). One or more fixed shafts/pins (36) may also be provided between inner end wall (20) and outer end wall (16) for attachment and spacing purposes. As is shown, each of the drive shaft (38) and the rotating shafts (32, 34) has a longitudinal axis that is parallel to a longitudinal axis defined by the generally cylindrical side wall (14), and is generally perpendicular to the generally planar inner and outer end walls (16, 20).

Although not shown, it is also contemplated that instead of the gear train being formed by separate gears mounted on shafts/pins disposed between the inner end wall (20) and outer end wall (16), the gear train may be formed as part of the gearmotor (24) itself, such as being formed as a gearbox housed within, or attached directly to, the housing of the gearmotor (24).

In operable connection with the side of the gear train opposite to the gearmotor (24) is a cam (40), such as a clover cam, which, in turn, cooperates with the deadbolt (not shown in FIG. 1) in a known manner. In the shown embodiment, the rotating shaft (32) which carries the third gear (30) extends through inner end wall (20), and the cam (40) is carried on the end of the rotating shaft (32) extending through the inner end wall (20), so as to be disposed outside of the housing (12).

By way of the gear train, the cam (40) rotates with an increase in mechanical advantage as compared to rotation of the drive shaft (38) of the motor (24). In a preferred embodiment, wherein the cam (40) comprises a generally planar clover cam, the cam (40) is disposed to be generally parallel to the generally planar inner end wall (20), and the cam (40) rotates in a plane that is generally parallel to the generally planar inner end wall (20).

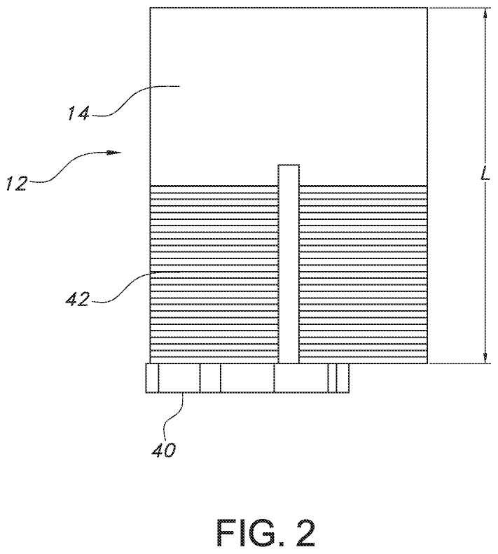

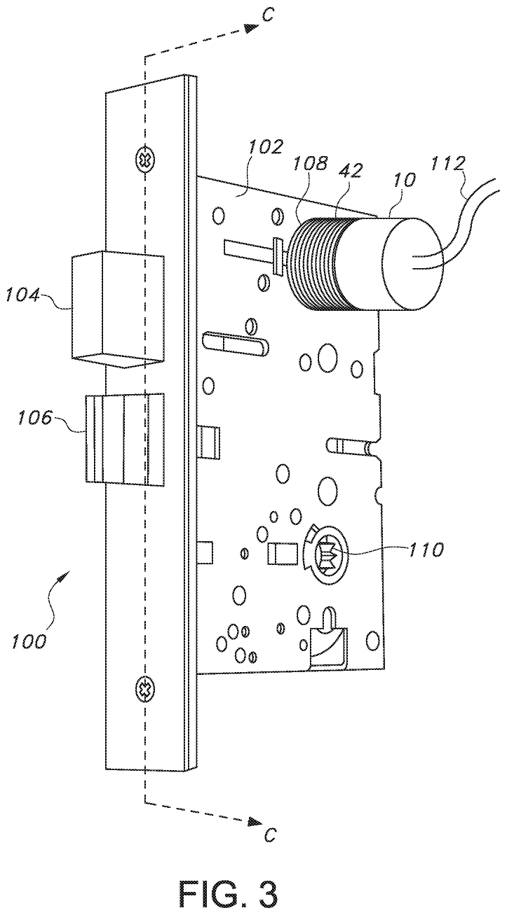

Turning now to FIG. 2, which shows the fully assembled motorized cylinder (10), illustrated is the fact that the exemplary generally cylindrical side wall (14) has a longitudinal length (L) less than about 1.5 inches. While there is nothing critical about this exact dimension in all circumstances, it is worth nothing that a typical door has a width of about 2.0 inches or less. In addition to that, a typical door may include a cylinder collar of up to 0.5 inches on each side, for a total thickness of 3.0 inches. Thus, since the motorized cylinder would typically be mounted to one side of the door centerline (indicated by reference character C in FIG. 3), a total length of 1.5 inches or less for the housing (12) ensures that the motorized cylinder (10) would fit within the envelope for a typical door without requiring additional surface mounted features, which may be aesthetically unappealing. Of course, if a thinner door and/or a thinner cylinder collar is desired, the total length of the motorized cylinder (10) could be further reduced.

Referring now to FIG. 3, the inventive motorized cylinder (10) is shown mounted to a typical mortise lock body (100), as are designed for installation in a mortise (or pocket) formed in a door. It is worth noting that the mortise lock body (100) does not require customization in order to accommodate the inventive motorized cylinder (10). Instead, the mortise lock body (100) includes typical well-known components, including a housing (102) for containing the majority of the components of the assembly. Sometimes, the housing is referred to as a lock case.

Extending from the housing (102) are a deadbolt (104) and a latch (106), as is typical. The deadbolt (104) and latch (106) are shown in their extended positions in which, if the lock body (100) were installed in a door, the deadbolt (104) and latch (106) would protrude through corresponding openings in a strike plate of a doorframe to lock the door. Although not shown in the figures, corresponding holes are cut in the doorframe to accommodate the deadbolt (104) and latch (106) when the door is closed and locked.

The lock body (100) also includes a circular opening or cylinder port (108) for accommodating a deadbolt cylinder. In this case, the deadbolt cylinder comprises the motorized deadbolt cylinder (10) of the present invention. As is known in the art, the deadbolt cylinder interacts with the deadbolt (104), via well-known deadbolt actuation components disposed within housing (102) to move it between the extended position shown in FIG. 3 and a retracted position. Typically, the deadbolt lock cylinder requires use of a key on at least one side of the door to turn the lock. (In many embodiments, both sides of the lock cylinder require use of a key to turn the lock cylinder).

The lock body (100) also includes a follower hole (110), which is adapted to accommodate a spindle (not shown). The spindle connects a follower to a door handle (not shown) in a well-known manner. When the door handle is turned, the spindle rotates the follower, which imparts lateral movement to the latch (106) via well-known latch actuation components disposed within housing (102). The latch (106) can be moved between an extended position (as shown in FIG. 3) and a retracted position.

Instead of requiring customization of the lock body (100), the motorized cylinder is simply screwed into a threaded opening on one side of the mortise lock housing (102), just as would be a traditional manual deadbolt cylinder. In order to achieve this connection, the housing (12) of the motorized deadbolt cylinder (10) comprises male threads (42) disposed on an outer surface of the generally cylindrical side wall (14), the male threads (42) adapted to cooperate with the female threads already typically provided in the cylinder port (108) of known mortise lock bodies (100).

While a mortise lock is shown, it should be noted, however, that the inventive motorized cylinder (10) can also be used in connection with a bored cylinder lock type of deadbolt instead.

Although not shown, the side of the deadbolt opposite to the motorized cylinder (10) may include a thumb turn, for example, to facilitate egress from a building without requiring the mechanism (e.g., Bluetooth device, key fob, keypad, etc.) used to trigger motorized opening/closing of the deadbolt from the motorized side.

When a thumb turn or the like is used in combination with the motorized cylinder (10), such that the deadbolt may be extended and/or retracted manually, the motorized cylinder may include a staging ability in order to be prepared for a subsequent opening or closing command. For example, suppose that the deadbolt is in the extended, locked position, and then the thumb turn is manually used to retract the deadbolt. This manual retraction may be sensed by the motorized cylinder (10), and then the motorized cylinder may stage itself—i.e., move the cam (40) to correspond to the retracted position to match the manual positioning to the retracted position—so that the motorized cylinder (10) is prepared to receive and act upon a command to move the deadbolt again to the extended position. This same type of staging may be employed in the opposite direction also—i.e., to stage itself if the thumb turn or the like is used to manually move the deadbolt to the extended position.

With respect to power for the motorized cylinder (10), various mechanisms are contemplated, with wiring (112) for the motor being shown in FIG. 3. If an AC motor is employed, a wired connection to mains power through the door and the door frame may be provided. However, when a DC motor is employed (as is generally preferred), various options exist. For example, a wired connection to mains power could be used with an AC/DC transformer, though such may not be optimal. Alternately, replaceable batteries could be employed, using single use or rechargeable batteries that must be replaced by a user.

However, a preferred option may be to employ a rechargeable battery disposed in the door that is electrically connected to a power jump positioned between the door and the door frame. This would allow for the battery to be slowly charged at very low power (typically lower than would be required to extend/retract the deadbolt) while the door is closed, without requiring a wired connection between the door frame and the door. Then, when commanded, the battery could provide a surge of power at a level needed in order to extend/retract the deadbolt. Such an arrangement provides for reliable operation and ease of use.

The present invention thus provides a motorized deadbolt assembly having a motorized cylinder capable of being installed within the envelope of typical deadbolt designs (i.e., not requiring additional aesthetically unappealing structures mounted on the inner and/or outer surfaces of the door). The present invention also provides a motorized cylinder that can be retrofit for use with existing deadbolt designs, such that significant redesign thereof is not required.

What is claimed is:

1. A motorized deadbolt cylinder assembly comprising:
a housing having a generally cylindrical side wall, a generally planar outer end wall disposed at a first end of said generally cylindrical side wall and a generally planar inner end wall disposed at a second end of said generally cylindrical side wall opposite to the first end;
a motor disposed within said housing, said motor having a drive shaft;
a cam arranged on the generally planar inner end wall and arranged such that at least a portion thereof is disposed outside of said housing; and
a gear train operably connected between the drive shaft of said motor and said cam such that rotation of the drive shaft of said motor causes rotation of said cam, such that said cam rotates with an increase in mechanical advantage as compared to rotation of the drive shaft of said motor.

2. The assembly according to claim 1 wherein said generally cylindrical side wall has a longitudinal axis, wherein the drive shaft of said motor has a longitudinal axis, and wherein the longitudinal axis of said generally cylindrical side wall and the longitudinal axis of the drive shaft of said motor are parallel.

3. The assembly according to claim 1 wherein said cam comprises a generally planar clover cam which is disposed to be generally parallel to said generally planar inner end wall.

4. The assembly according to claim 3 wherein said generally planar clover cam rotates in a plane that is generally parallel to said generally planar inner end wall.

5. The assembly according to claim 1 wherein said generally cylindrical side wall has a longitudinal length less than about 1.5 inches, whereby said assembly is adapted to be arranged such that said cam is disposed on a centerline of a door with said housing being completely disposed to one side of the centerline of the door.

6. The assembly according to claim 1 wherein said motor comprises a direct current motor.

7. The assembly according to claim 6 wherein said gear train is formed as a unit as part of the direct current motor.

8. The assembly according to claim 1 wherein said gear train comprises a plurality of gears disposed between said generally planar outer end wall and said generally planar inner end wall.

9. The assembly according to claim 8 wherein each of the plurality of gears rotates about an axis extending between, and arranged generally perpendicular to, said generally planar outer end wall and said generally planar inner end wall.

10. The assembly according to claim 9 wherein said gear train comprises:
a first gear which is driven by the drive shaft of said motor;
a second gear comprising a larger diameter section and a smaller diameter section, the larger diameter section being driven by the first gear; and
a third gear driven by the smaller diameter section of said second gear, said third gear driving said cam.

11. The assembly according to claim 10 further comprising a rotatable shaft extending through said generally planar inner end wall, a first portion of said rotatable shaft being affixed to said third gear, and a second portion of said rotatable shaft being affixed to said cam.

12. The assembly according to claim 1 wherein said housing further comprises an attachment section adapted to be attached to a mortise lock body.

13. The assembly according to claim 12 wherein the attachment section of said housing comprises male threads disposed on an outer surface of said generally cylindrical side wall, the male threads adapted to cooperate with female threads disposed on the mortise lock body.

14. A motorized mortise lock assembly comprising;
a mortise lock body having deadbolt components disposed therein and having an opening formed therein through which the deadbolt components are accessible, said mortise lock body defining a generally planar centerline, wherein the opening is generally perpendicular to the generally planar centerline;
a deadbolt cylinder housing having a generally cylindrical side wall, a generally planar outer end wall disposed at a first end of said generally cylindrical side wall and a generally planar inner end wall disposed at a second end of said generally cylindrical side wall opposite to the first end;
a motor disposed within said deadbolt cylinder housing, said motor having a drive shaft;
a cam arranged on the generally planar inner end wall and arranged such that at least a portion thereof is disposed outside of said deadbolt cylinder housing;
a gear train operably connected between the drive shaft of said motor and said cam such that rotation of the drive shaft of said motor causes rotation of said cam, such that said cam rotates with an increase in mechanical advantage as compared to rotation of the drive shaft of said motor, and wherein the portion of said cam disposed outside of said deadbolt cylinder housing cooperates with the deadbolt components of the mortise lock body upon rotation of said cam; and
wherein said cam and said deadbolt cylinder housing are arranged such that said cam is disposed on the centerline of said mortise lock body and said deadbolt cylinder housing is completely disposed to one side of the centerline of said mortise lock body.

15. The assembly according to claim 14 wherein said generally cylindrical side wall has a longitudinal length less than about 1.5 inches.

16. The assembly according to claim 14 wherein said generally cylindrical side wall has male threads formed on an outer surface thereof, wherein the opening formed in the mortise lock body has female threads formed therein, and wherein the deadbolt cylinder housing is attached to the mortise lock body by way of the male and female threads.

17. The assembly according to claim 14 wherein said generally cylindrical side wall has a longitudinal axis, wherein the drive shaft of said motor has a longitudinal axis, and wherein the longitudinal axis of said generally cylindrical side wall and the longitudinal axis of the drive shaft of said motor are parallel.

18. The assembly according to claim 14 wherein said cam comprises a generally planar clover cam which is disposed to be generally parallel to said generally planar inner end wall.

19. The assembly according to claim 18 wherein said generally planar clover cam rotates in a plane that is generally parallel to said generally planar inner end wall.

20. The assembly according to claim 14 wherein said gear train comprises a plurality of gears disposed between said generally planar outer end wall and said generally planar inner end wall.

21. The assembly according to claim 20 wherein each of the plurality of gears rotates about an axis extending between, and arranged generally perpendicular to, said generally planar outer end wall and said generally planar inner end wall.

22. The assembly according to claim 21 wherein said gear train comprises:
a first gear which is driven by the drive shaft of said motor;
a second gear comprising a larger diameter section and a smaller diameter section, the larger diameter section being driven by the first gear; and
a third gear driven by the smaller diameter section of said second gear, said third gear driving said cam.

23. The assembly according to claim 22 further comprising a rotatable shaft extending through said generally planar inner end wall, a first portion of said rotatable shaft being affixed to said third gear, and a second portion of said rotatable shaft being affixed to said cam.
